(19) United States
(12) Patent Application Publication
(10) Pub. No.: US 2007/0064905 A1
(43) Pub. Date: Mar. 22, 2007

(54) TELEPHONE APPARATUS, TELEPHONE SYSTEM AND FACSIMILE APPARATUS

(75) Inventor: Mikio MIZUTANI, Tokyo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/421,953

(22) Filed: Jun. 2, 2006

(30) Foreign Application Priority Data
Sep. 12, 2005 (JP) 2005/263573

(51) Int. Cl. H04M 3/42

(52) U.S. Cl. 379/207.03

(57) ABSTRACT

An IP telephone apparatus includes a recording unit, a timestamp token obtaining unit, an operation unit and a data accumulation unit. The recording unit generates recorded data by recording a voice. The timestamp token obtaining unit obtains a timestamp token including encrypted data of the recorded data or digest-data thereof with time information attached. The operation unit initiates the timestamp token obtaining process of the timestamp token obtaining unit. The data accumulation unit accumulates, together with the recorded data, the timestamp token obtained by the timestamp token obtaining unit. By using the IP telephone apparatus, notarized recorded data can be easily obtained and freely handled.

### BACKGROUND OF THE INVENTION

1. Field of the Invention

The present invention relates to an IP telephone apparatus, an IP telephone system and an IP facsimile apparatus that have a timestamp function for notarizing recording date and time of recorded data.

2. Description of Related Art

In recent years, an IP telephone apparatus that communicates voice data with a destination apparatus via an IP network is rapidly gaining popularity, because of the advantages of low rates and multifunctionality. Further, a recording function for recording voice during user's absence or during a call is normally provided in a telephone apparatus, and the recording function has been frequently used.

Related to the call recording function, there is a system which, linked to a timestamp server and a time notary center, can issue a timestamp token for notarizing date and time of data recorded during a call and facsimile data (see Related Art 1). In this system, a client obtains a timestamp token for recorded data and facsimile data by using a timestamp-obtaining unit provided in a switch.

[Related Art 1] Japanese Patent Laid Open Publication 2004-194306.

However, in the case of a recording function usually provided in a telephone apparatus, time information based on an internal clock is attached to recorded data. Although a user can recognize date and time of recording based on the time information, the time information has no notarizing authority. Therefore, there is a problem that the time when the recording was performed cannot be clearly and strictly certified.

On the other hand, in the above-mentioned system, in which a timestamp token is created in a switch, time of a call and time of a facsimile communication can be certified with notarizing authority. However, there is a problem that the created timestamp token is kept in the server and cannot be easily obtained and used by a general user according to the user's needs.

### SUMMARY OF THE INVENTION

The present invention is provided to resolve the above-described problems associated with the conventional technology. The main purpose of the present invention is to provide a telephone apparatus, a telephone system and a facsimile apparatus, which are so configured that a timestamp token can be easily obtained on the user side and, further, the obtained timestamp token can be freely utilized.

In order to achieve the above-described objective, as indicated in claim 1, the telephone apparatus of the present invention, which is connected with another telephone apparatus and a time delivery authority to transmit time information via a network, comprises a memory to store data, a recording unit to record recording data in said memory according to voice data communicated with the another telephone apparatus, a communication unit to transmit a request for the time information to the time delivery authority, a digest data generator to generate digest data based on the recording data recorded in said memory, a time stamp unit to encrypt the digest data and the time information and to generate time stamp token, and a data writing unit to record the time stamp token in said memory.

According to the present invention, the timestamp token notarizing the date and time of the recorded data can be easily obtained on the user side.

In this case, for the digest-data, data based on an irreversible transformation, in particular, hash values computed by using a hash function, are among the most suitable.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block diagram illustrating an IP telephone apparatus according to a first embodiment of the present invention;

FIG. 2 is a plain view showing an exterior appearance of the IP telephone apparatus of FIG. 1;

FIG. 3 shows an example of a list of recorded data sets in the IP telephone apparatus of FIG. 1;

FIG. 4 is a flow chart describing an operation for generating notarized recorded data in the IP telephone apparatus of FIG. 1;

FIG. 5 is a flow chart describing a modified example of the operation of the IP telephone apparatus shown in FIG. 4;

FIG. 6 is a block diagram illustrating an IP telephone apparatus according to a second embodiment of the present invention;

FIG. 7 is a flow chart describing an operation for generating notarized recorded data in the IP telephone apparatus of FIG. 6;

FIG. 8 is a flow chart describing a modified example of the operation of IP telephone apparatus shown in FIG. 7;

FIG. 9 is a block diagram illustrating an IP telephone apparatus according to a third embodiment of the present invention; and

FIG. 10 is a block diagram illustrating an IP facsimile apparatus according to a fourth embodiment of the present invention.

### DETAILED DESCRIPTION OF PREFERRED EMBODIMENTS

The embodiments of the present invention are explained in the following with reference to the above-described drawings.

### First Embodiment

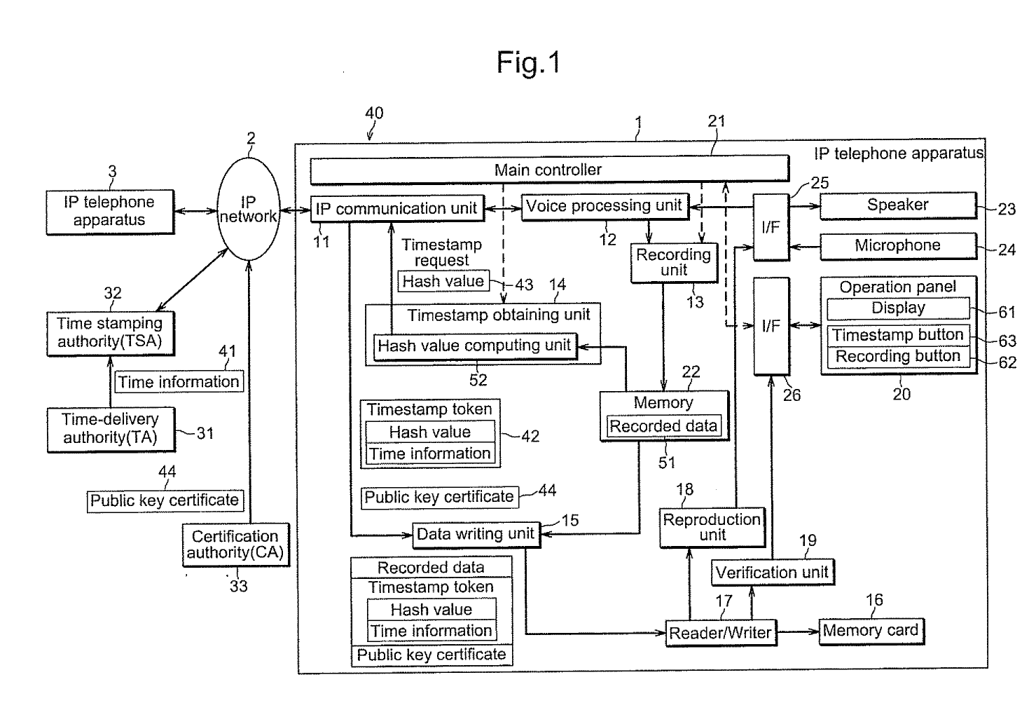

FIG. 1 is a block diagram illustrating an IP telephone apparatus according to a first embodiment of the present invention. IP telephone apparatus 1 performs voice communication with IP telephone apparatus (hereafter referred to as “destination apparatus”) 3 via IP network 2 by using a VoIP (voice over internet protocol) technology to convert voice into IP packets. IP telephone apparatus 1 has a timestamp function for notarizing recorded data generated by recording voice in the voice communication. IP telephone apparatus 1 includes chiefly IP communication unit 11, voice processing unit 12, recording unit 13, timestamp obtaining unit 14, data writing unit 15, memory card 16, reader/writer 17, reproduction unit 18, verification unit 19, operation panel 20, main controller 21, memory 22, speaker 23, microphone 24, speaker/microphone I/F 25 and operation panel I/F 26. Besides destination apparatus 3, IP telephone apparatus 1 is connected via IP network 2 to time-delivery authority (TA) 31, time stamping authority (TSA) 32 and certification authority (CA) 33. All of these collectively comprise IP telephone system 40.

In IP telephone system 40, time-delivery authority 31 delivers, to time stamping authority 32, time information 41 based on a standard time, and authenticates the time of time stamping authority 32.

Time stamping authority 32 receives authentication of time from time-delivery authority 31, and issues a timestamp token (time certificate) 42 in response to a timestamp request from IP telephone apparatus 1. Timestamp token 42 is issued as an encryption of a combination of hash value 43 sent from a user and time information and the like attached to hash value 43, by using a private key (that is, it is issued as a digital signature). Timestamp token 42 enables certification that a user's electronic data (recorded data and the like) corresponding to hash value 43 are in a state as of the time indicated by time information 41 contained in timestamp token 42 (that is, no improper alteration after the time), and that the user's electronic data existed before the time.

Certification authority 33 certifies validity of a public key by issuing public key certificate 44, which correlates the public key to an entity on the network. In the current embodiment, certification authority 33 certifies the issuer of timestamp token 42 by issuing public key certificate 44 for the public key corresponding to the private key used by time stamping authority 32 when issuing timestamp token 42. This enables a receiver of the public key (verifier of the time) to confirm whether the public key is valid (i.e., whether or not the public key is issued by time stamping authority 32) by using public key certificate 44. Further, it is possible to prevent alteration of the public key certificate itself by adding an electronic signature of certification authority 33 to public key certificate 44.

IP communication unit 11 of IP telephone apparatus 1 transmits and receives voice data related to a telephone call to and from destination apparatus 3 via IP network 2 according to a predetermined communication protocol, and also transmits and receives, to and from time stamping authority 32 and certification authority 33, data related to the timestamp function (a timestamp request, a timestamp token, a public key certificate and the like).

Voice processing unit 12 has a function for AD and D/A conversions of transmission data and reception data, and a voice CODEC function based on a predetermined encoding method (for example, ITU-T recommendation G.711 and G.729). In other words, voice processing unit 12 creates transmission data by performing an AND conversion for analog signals of a transmission voice and encoding the converted digital data; and, at the same time, voice processing unit 12 generates analog signals of a reception voice by decoding encoded reception data and performing a D/A conversion for the decoded digital data.

Recording unit 13 records transmission voice transmitted to destination apparatus 3 and reception voice received from destination apparatus 3 (voice of a telephone call). Generated recorded data 51 are saved to memory 22. Recorded data 51 can be generated in a variety of file formats based on the transmission data and reception data obtained from voice processing unit 12, and can be suitably compressed as far as voice quality required for reproducing voice can be maintained. Further, the voice, which is to be recorded, is not limited to voice during a telephone call. It may also include sound captured by microphone 24 and reception voice recorded by using an answering machine function, when IP telephone apparatus 1 is not used for a telephone call.

Timestamp obtaining unit 14 executes a process for obtaining timestamp token 42 from time stamping authority 32. Hash value computing unit 52 of timestamp obtaining unit 14 obtains recorded data 51, which require notarization, from memory 22, computes hash value 43 as digest data of recorded data 51, and requests a timestamp by transmitting hash value 43 to time stamping authority 32. The digest data is a fixed length data obtained from original data by using an irreversible one-way function, for example, hash value obtained by using hash function. The same digest data can be obtained from identical data, while there is a very few probability that the same digest data is obtained from different data.

Data writing unit 15 performs a process for saving recorded data 51, timestamp token 42 and public key certificate 44 to memory card 16 through reader/writer 17, recorded data 51 being accumulated in memory 22 and requiring notarization, timestamp token 42 being issued from time stamping authority 32, and public key certificate 44 being issued from certification authority 33 and containing a public key. When doing so, by creating an information table which correlates among recorded data 51, timestamp token 42 and public key certificate 44, it is also possible to save these data separately to different memory devices. Alternatively, it is also possible to put recorded data 51, timestamp token 42 and public key certificate 44 together and save them as one set of data.

Memory card (data accumulation unit) 16 is a nonvolatile memory medium, capable of storing a wide variety of data. By using reader/writer 17, a user can removably attach memory card 16 to IP telephone apparatus 1. Thereby, recorded data and the like can be saved to memory card 16, and recorded data and the like already stored in memory card 16 can be read out. The use of memory card 16 makes storing and handling of notarized recorded data easy.

Reproduction unit 18 performs a process for reproducing recorded data stored in memory card 16 and memory 22 and outputting voice from speaker 23. Thereby, a user can retrieve required voice data and determine whether notarization is required, by checking the content of the recorded data.

Verification unit 19 performs a process for verifying time by analyzing recorded data that have already been notarized and the corresponding timestamp token 42. More specifically, verification unit 19 makes hash value computing unit 52 to compute the hash value of the recorded data, which is to be verified, and compares the resulting hash value with the hash value obtained from the timestamp token, which is to be verified. As a result of the comparison, verification unit 19 determines that the time information of the timestamp token is valid when the two hash values are identical. In this case, the validity of the timestamp token can be determined based on the public key certificate.

It is also possible for verification unit 19 to perform verification by analyzing recorded data and a corresponding timestamp token obtained through memory card 16, the recorded data having been already notarized (with a timestamp token attached) by a separate data processing apparatus.

It is also possible to have a configuration in which IP telephone system 40 includes a data processing apparatus having the same function as verification unit 19, and the same verification is performed by the data processing apparatus. In this case, memory card 16 storing notarized recorded data is attached to the data processing apparatus so that the recorded data can be read to the data processing apparatus. Thereby, verification and reproduction can be easily performed.

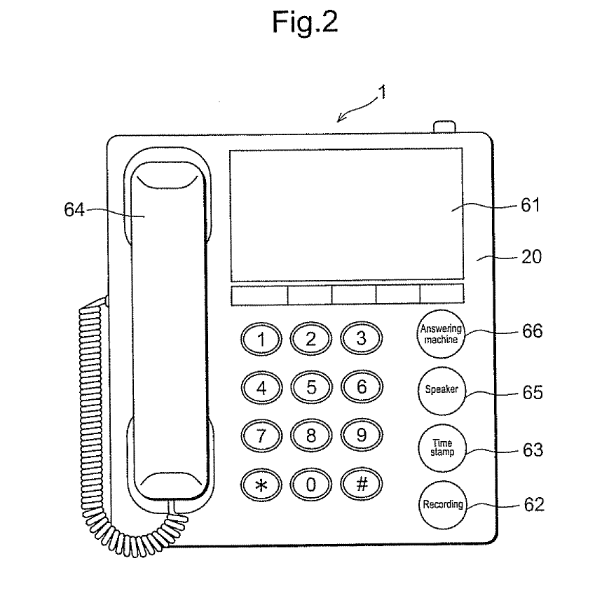

Operation panel 20 is for use to input settings related to the operation of IP telephone apparatus 1 and to obtain various information. As shown in FIG. 2, operation panel 20 includes display 61, recording button 62, timestamp button (operation unit) 63, speaker button 65, and answering machine button 66. Display 61 displays various information. Recording button 62 is used to make recording unit 13 to start recording voice. Timestamp button 63 is used to make hash value computing unit 52 to send out a timestamp request. Speaker button 65 is used to switch to a hands-free mode to output voice from speaker 23 without lifting handset 64. Answering machine button 66 is used to activate the answering machine function. When a user determines that it is necessary to record a telephone call or to record a message and the like when there is no telephone call in progress, the user can start recording by depressing recording button 62. When a user determines that it is necessary to notarize recorded data 51, the user can start a process for notarization by depressing timestamp button 63. Alternatively, it is also possible to have a configuration in which, without the need of depressing recording button 62, voice of a telephone call is always recorded and saved to memory 22, and, upon depressing timestamp button 63, a process for notarizing the recorded data stored in memory 22 is executed.

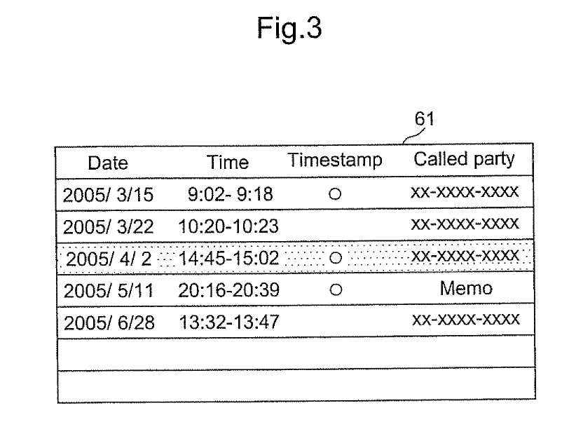

As shown in FIG. 3, a list of recorded data sets stored in memory 22 or memory card 16 can be displayed on display 61 of operation panel 20. Relevant information helpful for identifying each recorded data set is displayed. In this example, as relevant information, information for “date,” “time,” “timestamp” and “called party” of a recording are displayed. “Date” shows the date when each recorded data set was recorded. “Time” shows the starting and ending times of each recorded data set. “Timestamp” indicates whether a recorded data set has been notarized, using a circle mark. “Called party” shows a called party's telephone number “xx-xxxx-xxxx” for data recorded during a telephone call, and “memo” (which indicates a message recording) for data recorded when there was no telephone call in progress.

Thereby, a user can easily check whether a recorded data set has been notarized already, its attributes and the like, and can easily handle generated recorded data. The relevant information of a recorded data set is not limited to what is described above. A variety of information can be saved beforehand together with recorded data and displayed as needed on display 61.

Main controller 21 has an overall control over operations of the above-described units. In particular, with regard to the timestamp function of IP telephone apparatus 1, main controller 21 controls operations of the above-described recording unit 13, timestamp obtaining unit 14, operation panel 20 and the like.

Although destination apparatus 3 is not required to have a timestamp function as that of IP telephone apparatus 1, destination apparatus 3, same as IP telephone apparatus 1, has a function enabling voice communication by converting voice to IP packets, based on the VoIP technology.

Next, operations related to the above-described timestamp function of IP telephone apparatus 1 according to the first embodiment will be explained.

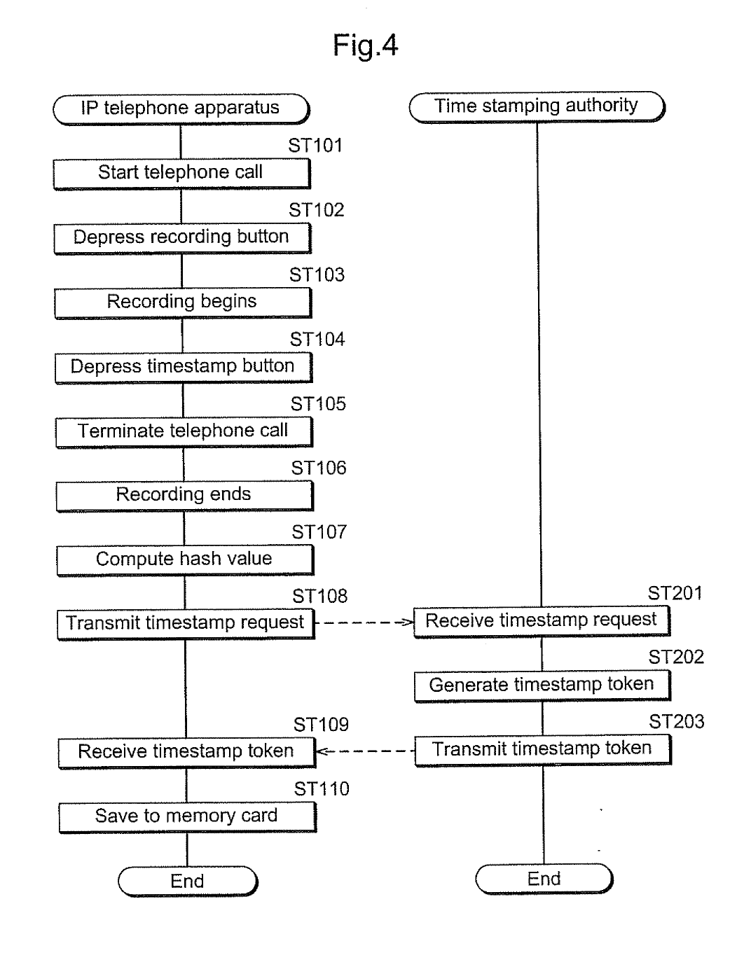

FIG. 4 is a flow chart describing an operation for generating notarized recorded data in the IP telephone apparatus shown in FIG. 1. FIG. 4 describes a case where a notarization process is executed after recording has started, according to an operation by a user during a telephone call.

First, the user picks up a handset of IP telephone apparatus 1 and starts a telephone call with destination apparatus 3 according to a predetermined connection protocol (for example, the H.323 protocol) (ST101). When the user decides that it is necessary to record the telephone call and depresses recording button 62 (ST 02), recording of the telephone call by recording unit 13 starts (ST103). Next, when the user decides that it is necessary to notarize the recorded data and depresses timestamp button 63 (ST104), main controller 21 activates the timestamp function. Thereafter, once the user terminates the telephone call by putting down the handset (ST105), the recording of the telephone call terminates (ST106). The termination of the recording does not always have to be after the termination of the telephone call. For example, it is also possible to have a configuration in which the recording is terminated by depressing the recording button again during the telephone call. Further, the depressing of timestamp button 63 in step ST104 does not always have to be in the middle of the recording. It is also possible for the user to do the operation when the user decides that it is necessary to notarize the recorded data after the telephone call has ended.

Once recorded data 51 are generated upon the termination of the recording, based on the activated timestamp function, hash value computing unit 52 computes hash value 43 of recorded data 51 (ST107), and timestamp obtaining unit 14 transmits, to time stamping authority 32, a timestamp request for hash value 43 (ST108). Time stamping authority 32 receives the timestamp request (ST201). In response to the request, time stamping authority 32 generates timestamp token 42 (ST202) and transmits timestamp token 42 to IP telephone apparatus 1 (ST203).

Once IP telephone apparatus 1 receives timestamp token 42 from time stamping authority 32 (ST1 O9), data writing unit 15 obtains recorded data 51, which are to be notarized, from memory 22, and saves recorded data 51, timestamp token 42 and corresponding public key certificate 44 to memory card 16 (ST110). By the series of operations described above, recorded data having date and time of recording notarized are obtained.

Public key certificate 44 relates to a public key corresponding to a private key of a digital signature when time stamping authority 32 issues timestamp token 42. Although omitted from the steps described above, after receiving timestamp token 42, IP telephone apparatus 1 can obtain public key certificate 44 by transmitting a request to certification authority 33.

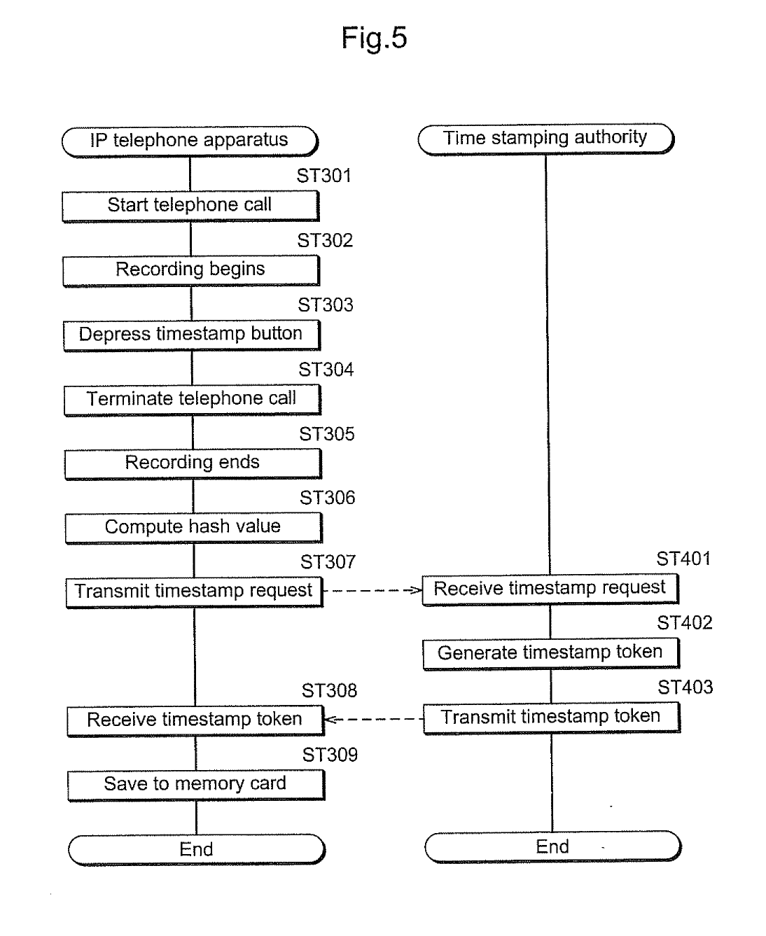

FIG. 5 is a flow chart describing a modified example of the operation of the IP telephone apparatus shown in FIG. 4. The operation shown in FIG. 5 is different from that of FIG. 4 in that recording of the voice of a telephone call is constantly performed, independent of the recording button. Further, items that are not specifically mentioned are the same as in the case of FIG. 4.

First, when a user starts a telephone call with destination apparatus 3 (ST301), recording of the voice of the telephone call is automatically started by recording unit 13 (ST302). Thereafter, when the user decides that it is necessary to notarize the recorded data and depresses timestamp button 63 (ST303), main controller 21 activates the timestamp function. Thereby, the data being recorded is specified to be notarized, and a notarization process will be executed after recorded data 51 is generated.

After timestamp button 63 is depressed, the operation of IP telephone apparatus 1 (ST304-ST309) and the operation of time stamping authority 32 (ST401-ST403) are the same as the operation of IP telephone apparatus 1 (ST105-ST110) and the operation of time stamping authority 32 (ST201-ST203) shown in FIG. 4, respectively.

According to the above-described configuration, even in a case such as when the user realized in the middle of (or after) a telephone call that notarization is necessary, it is still possible to specify the data recorded from the beginning of the telephone as data to be notarized. Further, it is also possible to have a configuration in which the constantly recorded voice of a telephone call is temporarily accumulated in a separate memory device or the like, and, by depressing the timestamp button, the temporarily accumulated recorded data is saved to memory 22 as data to be notarized. In this case, unneeded recorded data is not accumulated and can be deleted sequentially, thereby enabling an effective use of memory 22.

### Second Embodiment

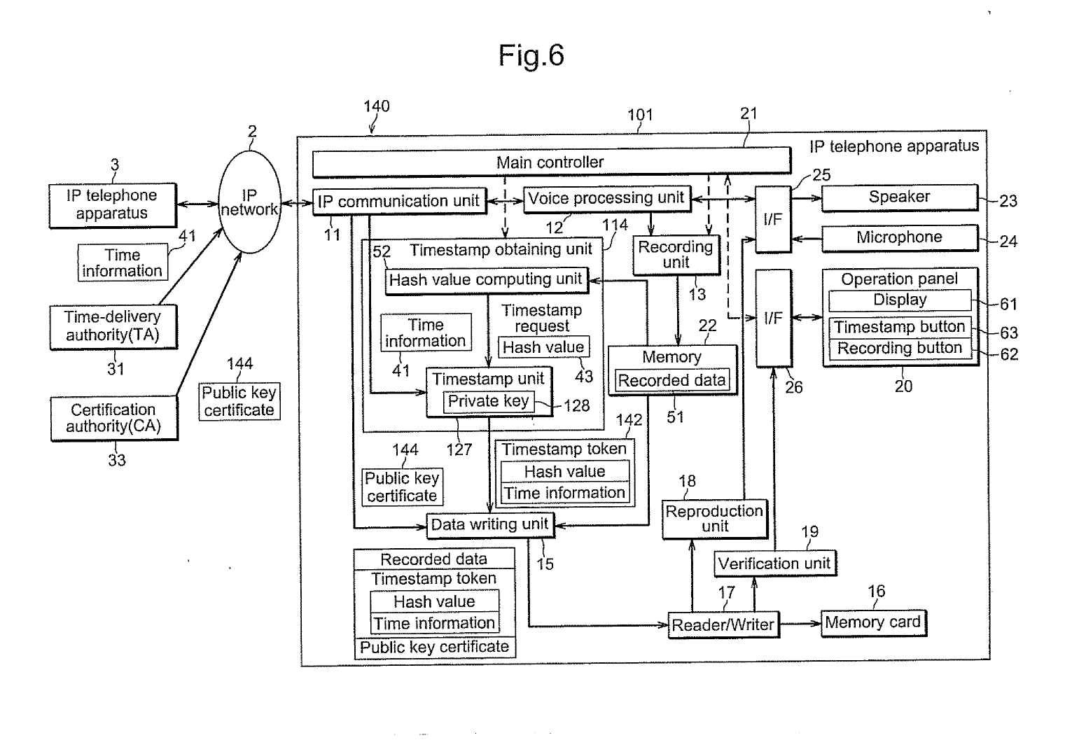

FIG. 6 is a block diagram illustrating an IP telephone apparatus according to a second embodiment of the present invention. Although IP telephone apparatus 101 has a configuration that is basically the same as IP telephone apparatus 1 shown in FIG. 1, it is different from IP telephone apparatus 1 shown in FIG. 1 in that a timestamp obtaining unit has the same function as time stamping authority 32 shown in FIG. 1. In FIG. 6, the components that are the same as in IP telephone apparatus 1 of FIG. 1 are assigned the same numbers, and items that are not specifically mentioned are the same as in the case of IP telephone apparatus 1 of FIG. 1. In the present embodiment, time stamping authority 32 shown in FIG. 1 is no longer required in IP telephone system 140.

In timestamp obtaining unit 114 of IP telephone apparatus 101, hash value computing unit 52 computes hash value 43 as a digest data of recorded data 51, which requires notarization, and timestamp unit 127 attaches time information and the like to hash value 43 and generates a digital signature using private key 128. Thereby, timestamp obtaining unit 114 issues timestamp token 142.

At this time, time-delivery authority 31 delivers time information 41, which is based on a standard time, to timestamp unit 127, and certifies the time of timestamp unit 127. Certification authority 33 certifies the issuer of timestamp token 142 by issuing public key certificate 144 for a public key corresponding to private key 128, which is used by timestamp unit 127 when issuing timestamp token 142. Data writing unit 15 saves recorded data 51, timestamp token 142 and public key certificate 144 to memory card 16 via reader/writer 17, recorded data 51 being accumulated in memory 22 and needing notarization, timestamp token 142 being issued by timestamp unit 127, and public key certificate 144 containing the public key and being issued by certification authority 33.

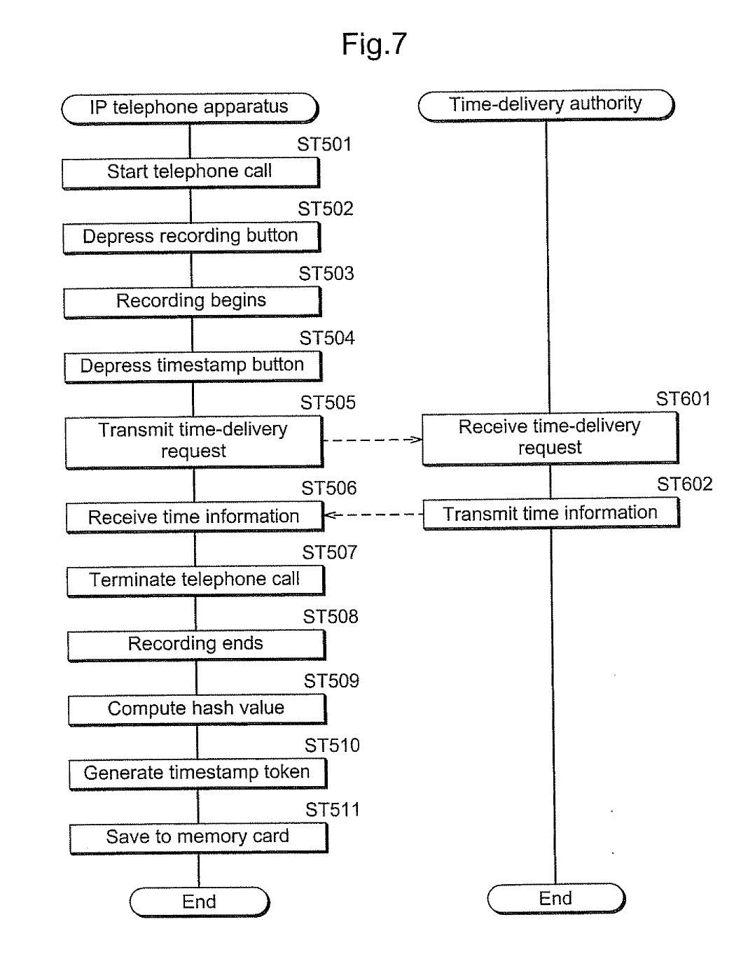

FIG. 7 is a flow chart describing an operation for generating notarized recorded data in the IP telephone apparatus of FIG. 6. Similar to the case of FIG. 4, FIG. 7 describes a case where a notarization process is executed after recording has started, in response to an operation by a user during a telephone call.

First, the user picks up a handset of IP telephone apparatus 101 and starts a telephone call with destination apparatus 3 according to a predetermined connection protocol (for example, the H.323 protocol) (ST501). When the user depresses recording button 62 (ST502), recording of the telephone call by recording unit 13 starts (ST503). Next, when the user depresses timestamp button 63 during recording (ST504), timestamp unit 127 transmits a time-delivery request to time-delivery authority 31 (ST505). Upon receiving the time-delivery request (ST601), time-delivery authority 31 transmits current time information 41 to IP telephone apparatus 101 in response to the request (ST602). IP telephone apparatus 101 receives time information 41 from time-delivery authority 31 (ST506). Thereafter, when the user puts down the handset and terminates the telephone call (ST507), the recording of the telephone call terminates (ST508). The termination of the recording does not always have to be after the termination of the telephone call. For example, it is also possible to have a configuration in which the recording is terminated by depressing recording button 62 again during the telephone call. Further, the depressing of timestamp button 63 in step ST504 does not always have to be during the recording. It is also possible for the user to do the operation when the user decides that it is necessary to notarize the recorded data after the telephone call has ended.

Once recorded data 51 are generated upon the termination of the recording, timestamp obtaining unit 114 computes hash value 43 of recorded data 51 by using hash value computing unit 52 (ST509), and generates timestamp token 142 by attaching time information 41 and the like to hash value 43 and generating a digital signature using private key 128 (ST510). Data writing unit 15 obtains timestamp token 142 generated by timestamp obtaining unit 114, obtains recorded data 51, which is to be notarized, from memory 22, and saves timestamp token 142 and recorded data 51, together with public key certificate 144, to memory card 16 (ST511). By the above described series of operations, recorded data having notarized recording time are obtained.

Public key certificate 144 relates to a public key corresponding to a private key of a digital signature when timestamp unit 127 issues timestamp token 142. Although omitted from the steps described above, public key certificate 144 can be obtained by transmitting a request to certification authority 33, when timestamp token 142 is generated.

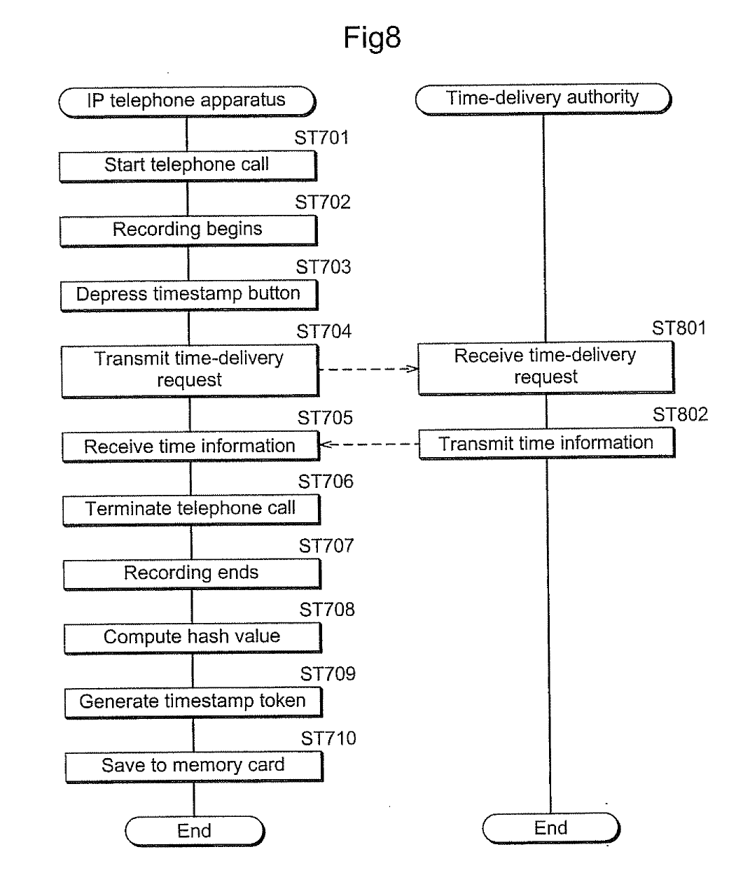

FIG. 8 is a flow chart describing a modified example of the operation of the IP telephone apparatus shown in FIG. 7. The operation shown in FIG. 8 is different from that of FIG. 7 in that the recording of a telephone call is constantly performed during the telephone call, independent of the recording button. Further, items that are not specifically mentioned are the same as in the case of FIG. 7.

First, when a user starts a telephone call with destination apparatus 3 (ST701), recording of the telephone call is automatically started by recording unit 13 (ST702). Thereafter, when the user decides that it is necessary to notarize the recorded data and depresses timestamp button 63 (ST703), main controller 21 activates the timestamp function. Thereby, the data being recorded is specified to be notarized, and a notarization process will be executed after recorded data 51 is generated.

After timestamp button 63 is depressed, the operation of IP telephone apparatus 101 (ST704-ST709) and the operation of time-delivery authority 31 (ST801, ST802) are the same as the operation of IP telephone apparatus 101 (ST505-ST511) and the operation of time-delivery authority 31 (ST601, ST602) shown in FIG. 7, respectively.

### Third Embodiment

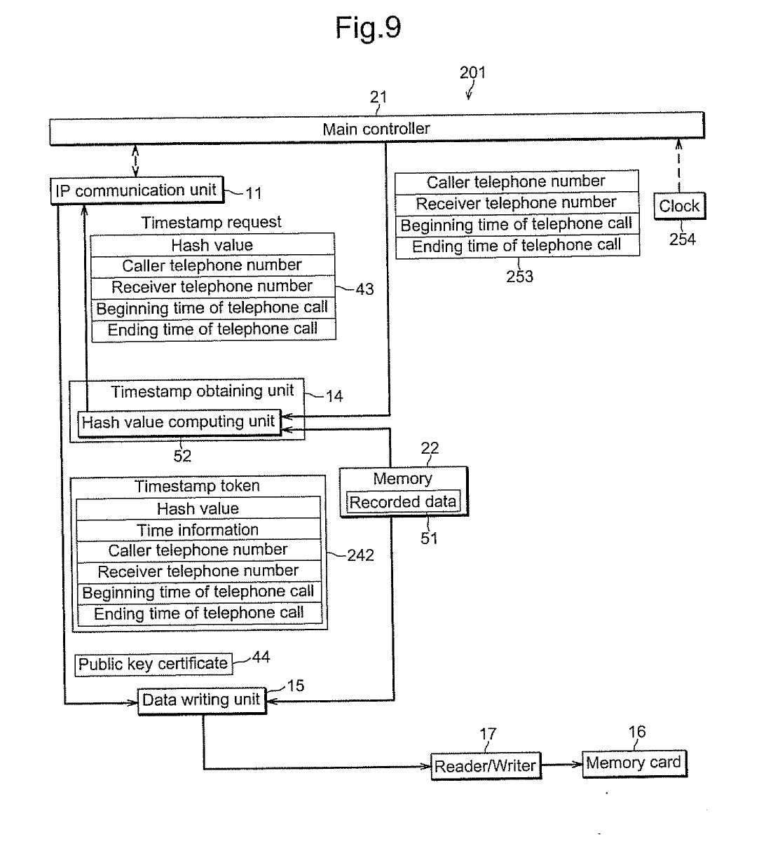

FIG. 9 is a block diagram illustrating an IP telephone apparatus according to a third embodiment of the present invention. Although IP telephone apparatus 201 has a configuration that is basically the same as IP telephone apparatus 1 according to the first embodiment shown in FIG. 1, it is different from IP telephone apparatus 1 shown in FIG. 1 in that relevant information is added to the recorded data, which is to be notarized. In FIG. 9, the components that are the same as in IP telephone apparatus 1 of FIG. 1 are assigned the same numbers, and, for simplicity, only substantial components are shown. Omitted components and items that are not specifically mentioned are the same as in the case of IP telephone apparatus 1 of FIG. 1.

In timestamp obtaining unit 14 of IP telephone apparatus 201, hash value computing unit 52 computes hash value 43 as a digest data of recorded data 51, which requires notarization, and main controller 21 obtains relevant information 253 of recorded data 51. Relevant information 253 includes information about the beginning and ending times of the telephone call, which are obtained from local clock (internal clock) 254 when the telephone call is made, and information about the caller and receiver telephone numbers (information identifying the caller and receiver), which are obtained from IP communication unit 11 when the telephone call is made. Further, hash value computing unit 52 combines computed hash value 43 and obtained relevant information 253, and transmits the combination to time stamping authority 32, thereby making a timestamp request. Time stamping authority 32 adds time information 41 to the data combining hash value 43 and relevant information 253, and issues timestamp token 242. Data writing unit 15 saves recorded data 51, timestamp token 242 and public key certificate 44 to memory card 16 via reader/writer 17, recorded data 51 being accumulated in memory 22 and needing notarization, timestamp token 242 being issued by time stamping authority 32, and public key certificate 44 containing the public key and being issued by certification authority 33.

As an alternative method, it is also possible to have a configuration in which hash value computing unit 52 combines recorded data 51 and relevant information 253, and computes the hash value of the combined data, and time stamping authority 32 issues a timestamp token for the hash value.

Further, the above described configuration, in which relevant information is added to the recorded data to be notarized, is similarly applicable to the IP telephone apparatus according to the second embodiment shown in FIG. 6. In this case, when the timestamp button is operated, based on the time information (confirmation time) obtained from the time delivery authority in response to the operation, it is possible to obtained a timestamp token having as the object of notarization the recorded data that has been attached the information, related to the beginning and ending times of the telephone call.

### Fourth Embodiment

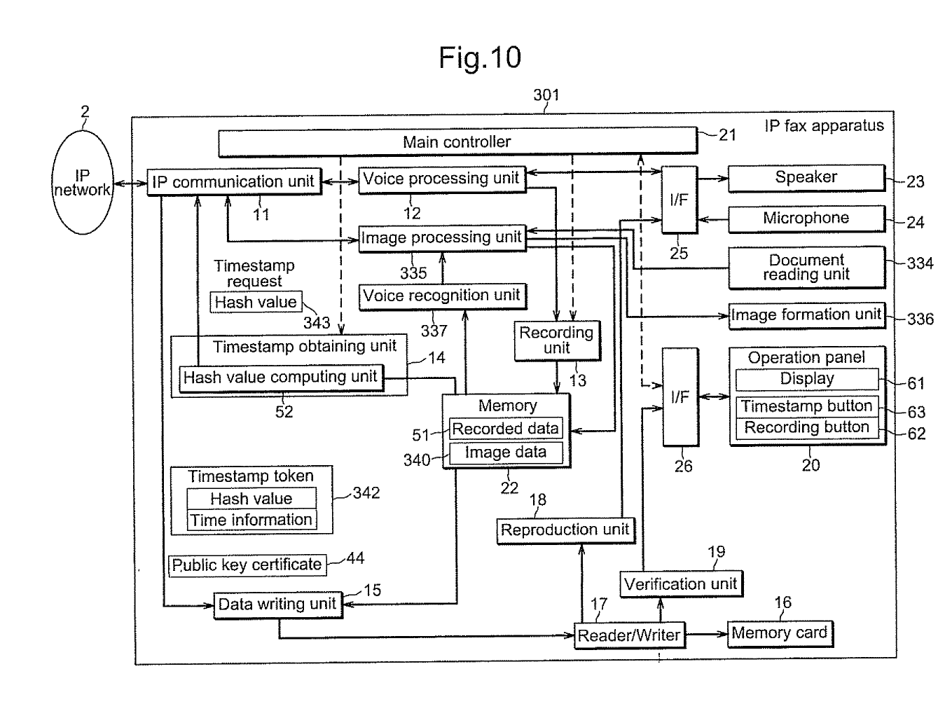

FIG. 10 is a block diagram illustrating an IP facsimile apparatus according to a fourth embodiment of the present invention. Although IP facsimile apparatus 301 has a configuration that is basically the same as IP telephone apparatus 1 according to the first embodiment shown in FIG. 1, it is different from IP telephone apparatus 1 in that a facsimile function is added and in that, in addition to recorded data, image data of a facsimile is also notarized. In FIG. 10, the components that are the same as in IP telephone apparatus 1 of FIG. 1 are assigned the same numbers, and items that are not specifically mentioned are the same as in the case of IP telephone apparatus 1 of FIG. 1.

In addition to the configuration of IP telephone apparatus 1 shown in FIG. 1, IP facsimile apparatus 301 further has document reading unit 334, image processing unit 335, image formation unit 336 and voice recognition unit 337. Document reading unit 334 scans documents and generates image data for facsimile communication. Image processing unit 335 has A/D and D/A conversion functions and performs predetermined image processing, such as image composition, reduction and rotation, to the image data. Image formation unit 336 produces images on predetermined papers, based on the processed image data. Voice recognition unit 337 generates text data by executing a voice recognition process on recorded data 51.

In IP facsimile apparatus 301, notarization process of recorded data 51 can be executed the same way as in the case of IP telephone apparatus 1 of FIG. 1. Notarization process of image data 340 is executed as follows.

First, image data received from a facsimile apparatus, are processed by image processing unit 335, and then accumulated in memory 22 as image data 340, which is to be notarized. In timestamp obtaining unit 14, hash value computing unit 52 obtains image data 340 that needs notarization, computes hash value 343 as a digest data of image data 340, and performs a timestamp request by transmitting hash value 343 to time stamping authority 32. Time stamping authority 32 adds time information to hash value 343 and issues timestamp token 342. Data writing unit 15 saves image data 340, timestamp token 342 and public key certificate 44 to memory card 16 via reader/writer 17, image data 340 being accumulated in memory 22 and needing notarization, timestamp token 142 being issued by time stamping authority 32, and public key certificate 44 containing a public key and being issued by certification authority 33. Thereby, image data having notarized recording date and time are obtained.

Image data 340 to be notarized is not limited to image data received from a facsimile apparatus, as described above. For example, image data 340 can also be image data generated by document reading unit 334 through scanning, or text data obtained by voice recognition unit 337 through performing a voice recognition process on recorded data 51. It is also possible to have a configuration in which image data 340 and recorded data 51 are combined together for notarization, and a timestamp token is issued by time stamping authority 32 for the hash value of the combined data.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2005-263573 filed on Sep. 12, 2005 entire content of which is expressly incorporated by reference herein.

What is claimed is:

1. A telephone apparatus configured to communicate over a network with another telephone apparatus and with a time delivery authority to transmit time information, the telephone apparatus comprising;
a memory configured to store data;
a recording unit configured to store recording data in said memory in accordance with voice data communicated with the another telephone apparatus;
a communication unit configured to transmit a request for the time information to the time delivery authority and to receive the time information transmitted from the time delivery authority;
a compressed data generator configured to generate compressed data based on the recording data stored in said memory;
a time stamp unit configured to encrypt the compressed data and the time information to generate a time stamp token; and
a data writing unit configured to store the time stamp token in said memory, the time stamp token being correlated with the recording data in said memory.

2. The telephone apparatus according to claim 1, wherein the compressed data generated by said compressed data generator is a hash value computed by a hash function.

3. The telephone apparatus according to claim 1 further comprising a operation button, wherein said communication unit transmits the request for the time information to the time delivery authority upon operation of said operation button.

4. The telephone apparatus according to claim 1, wherein said memory comprises a first memory to store the recording data and a second memory to store the time stamp token.

5. The telephone apparatus according to claim 4, wherein said second memory comprises a memory card removably attachable to the telephone apparatus.

6. A telephone apparatus configured to communicate over a network with another telephone apparatus, with a time delivery authority to transmit time information and with a certification authority to transmit private key information, public key information and public key certificate data, the telephone apparatus comprising;
a memory configured to store data;
a recording unit configured to store recording data in said memory in accordance with voice data communicated with the another telephone apparatus;
a communication unit configured to transmit a request for the time information to the time delivery authority and to receive the time information transmitted from the time delivery authority;
a compressed data generator configured to generate compressed data based on the recording data stored in said memory;
a time stamp unit configured to encrypt the compressed data and the time information by using the private key information and to generate time stamp token; and
a data writing unit configured to store the time stamp token in said memory, the time stamp token being correlated with the recording data in said memory and the public key certificate data.

7. The telephone apparatus according to claim 6, wherein the compressed data generated by said compressed data generator being a hash value computed by a hash function.

8. The telephone apparatus according to claim 6 further comprising a operation button, wherein said communication unit transmits the request for the time information to the time delivery authority upon operation of said operation button.

9. The telephone apparatus according to claim 6, wherein said memory comprises a first memory to store the recording data and a second memory to store the time stamp token.

10. The telephone apparatus according to claim 9, wherein said second memory comprises a memory card removably attachable to the telephone apparatus.

11. The telephone apparatus according to claim 6, wherein said time stamp unit encrypts the compressed data, the time information and additional information by using the private key information to generate the time stamp token.

12. The telephone apparatus according to claim 11, wherein the additional information comprises a telephone number associated with the telephone apparatus, a telephone number associated with the another telephone apparatus and telephone call time information associated with the recording data.

13. A facsimile apparatus configured to communicate over a network connecting with another facsimile apparatus, with a time delivery authority to transmit time information and with a certification authority to transmit private key information, public key information and public key certificate data, the facsimile apparatus comprising;
a memory configured to store data;
a reader configured to read image on a record media,
a facsimile communicator configured to communicate facsimile data with the another facsimile apparatus;
a recorder configured to record the image read by said reader and the facsimile data received by said facsimile communicator in said memory as image data;
a communication unit configured to transmit a request for the time information to the time delivery authority and to receive the time information transmitted from the time delivery authority;
a compressed data generator configured to generate compressed data based on the image data stored in said memory;
a time stamp unit configured to encrypt the compressed data and the time information by using the private key information and to generate time stamp token; and
a data writing unit configured to store the time stamp token in said memory, the time stamp token being correlated with the image data in said memory and with the public key certificate data.

14. The facsimile apparatus according to claim 13, wherein the compressed data generated by said compressed data generator is a hash value computed by a hash function.

15. The facsimile apparatus according to claim 13 further comprising a operation button, wherein said communication unit transmits the request for the time information to the time delivery authority upon operation of when said operation button.

16. The facsimile apparatus according to claim 13, wherein said memory comprises a first memory to store the image data and a second memory to store the time stamp token.

17. The facsimile apparatus according to claim 16, wherein said second memory comprises a memory card removably attachable to the telephone apparatus.

18. A communication system comprising;
a time delivery authority configured to transmit time information;
a time stamping authority connectable with said time delivery authority and configured to transmit a time stamp token in accordance with the time information transmitted from said time delivery authority;
a telephone apparatus configured to communicate over a network with said time delivery authority, said time stamping authority and an another telephone apparatus;
wherein said telephone apparatus comprises;
a memory configured to store data;
a recorder configured to store data in said memory in accordance with voice data communicated from the another telephone apparatus;
a communication unit configured to transmit a request for the time information to the time delivery authority and to receive the time information transmitted from the time delivery authority;
a compressed data generator configured to generate compressed data based on the data stored in said memory;
a time stamp obtainer configured to transmit the compressed data with the request to said time stamping authority and to receive the time stamp token from said time stamping authority; and
a data writing unit configured to store the time stamp token in said memory, the time stamp token being correlated with the data in said memory;
wherein said time stamping authority is configured to produce the time stamp token by encrypting the compressed data from said first telephone apparatus and the time information from said time delivery authority, and to transmit the time stamp token to said first telephone apparatus.

19. The communication system according to claim 18 further comprising a certification authority connectable with said time stamping authority, with said first telephone apparatus and with the another apparatus via the network, to transmit private key information, public key information and public key certificate data, the private key information and public key information being used for encrypting and decrypting;
wherein said time stamping authority produces the time stamp token in accordance with the private key information from said certification authority.

20. The communication system according to claim 19, wherein said data writing unit stores the time stamp token in said memory, the time stamp token being correlated with the data and with the private-key data.
